(19) United States
(12) Patent Application Publication
(10) Pub. No.: US 2012/0317440 A1
(43) Pub. Date: Dec. 13, 2012

(54) COMPILER INTERNAL FAULT HANDLING AND REPORTING

(75) Inventors: Ross Albert Towle, San Francisco, CA (US); Kurt Joachim Goebel, Dayton, OH (US)

(73) Assignee: ORACLE INTERNATIONAL CORPORATION,, Redwood City, CA (US)

(21) Appl. No.: 13/158,259

(22) Filed: Jun. 10, 2011

(51) Int. Cl. G06F 11/07

(52) U.S. Cl. 714/15; 714/E11.023

(57) ABSTRACT

Embodiments of the invention provide systems and methods for handling internal compiler errors encountered during compilation of a computer program without breaking the compilation. Implementations of a computer-implemented compiler system include a compiler driver, configured to compile a computer program according to a set of compiler settings, and a number of compiler components, each corresponding to a portion of the computer program. Each compiler component is configured to detect an internal compiler error during compilation of the component; identify a recovery plan having a recovery target and at least one recovery setting; and direct the driver to continue compiling the computer program according to the recovery plan, such that the compilation recompiles from the recovery target and according to a modified set of compiler settings according to the at least one recovery setting.

### FIELD

Embodiments of the present invention relate generally to compilers, and, more particularly, to compiler internal fault handling.

### BACKGROUND

The development of software applications typically involves writing software code in a high-level programming language and translating the code into a lower-level machine language that can be executed by a computer system. Many so-called “compiler” applications exist to effectuate the translation from the high-level “source code” into a lower-level “executable code.” These compilers may implement many different types of functionality, for example, that enhance the efficiency of the compilation process through automatic parallelization and other techniques.

Compiler applications, like any other software application, can encounter internal faults and unexpected conditions. Traditionally, the compiler is unable to recover from these types of internal errors, and compilation terminates without completion. Developers may then have to manually determine what issue occurred and where in the code that issue occurred, and may further have to manually report the issue to the compiler vendor and wait for a fix.

Particularly when the compilation process takes a long time or the issue is difficult to detect, this may be highly undesirable for developers. For example, internal compiler fault handling can significantly impact the software development cycle while waiting for fixes from the vendor, re-compilation of the source code, etc.

### BRIEF SUMMARY

Among other things, systems and methods are described for automatically handling internal compiler faults, and, in some cases, automatically reporting the internal faults, all without unnecessarily breaking the compilation process. Embodiments include a computer-implemented compiler system that has a compiler driver, configured to compile a computer program according to a set of compiler settings, and a number of compiler components, each corresponding to a portion of the computer program. Each compiler component is configured to detect an internal compiler error during compilation of the component; identify a recovery plan having a recovery target and at least one recovery setting; and direct the driver to continue compiling the computer program according to the recovery plan, such that the compilation recompiles from the recovery target and according to a modified set of compiler settings according to the at least one recovery setting.

### BRIEF DESCRIPTION OF THE DRAWINGS

The present disclosure is described in conjunction with the appended figures:

FIG. 1 shows a typical software development environment to provide a context for various embodiments.

FIG. 2 shows a block diagram of an exemplary compiler 110′ according to various embodiments.

FIG. 3 shows an exemplary computational environment 300, in the context of which various embodiments may be implemented.

FIG. 4 shows a flow diagram of an illustrative method 400 for compiling in unbreakable mode according to various embodiments.

FIG. 5 shows a flow diagram of another illustrative method 500 for compiling in unbreakable mode.

FIG. 6 shows an illustrative method 508′ for logging an internal compiler error according to various embodiments.

In the appended figures, similar components and/or features may have the same reference label. Further, various components of the same type may be distinguished by following the reference label by a second label that distinguishes among the similar components. If only the first reference label is used in the specification, the description is applicable to any one of the similar components having the same first reference label irrespective of the second reference label.

### DETAILED DESCRIPTION

In the following description, numerous specific details are set forth to provide a thorough understanding of the present invention. However, one having ordinary skill in the art should recognize that the invention may be practiced without these specific details. In some instances, circuits, structures, and techniques have not been shown in detail to avoid obscuring the present invention.

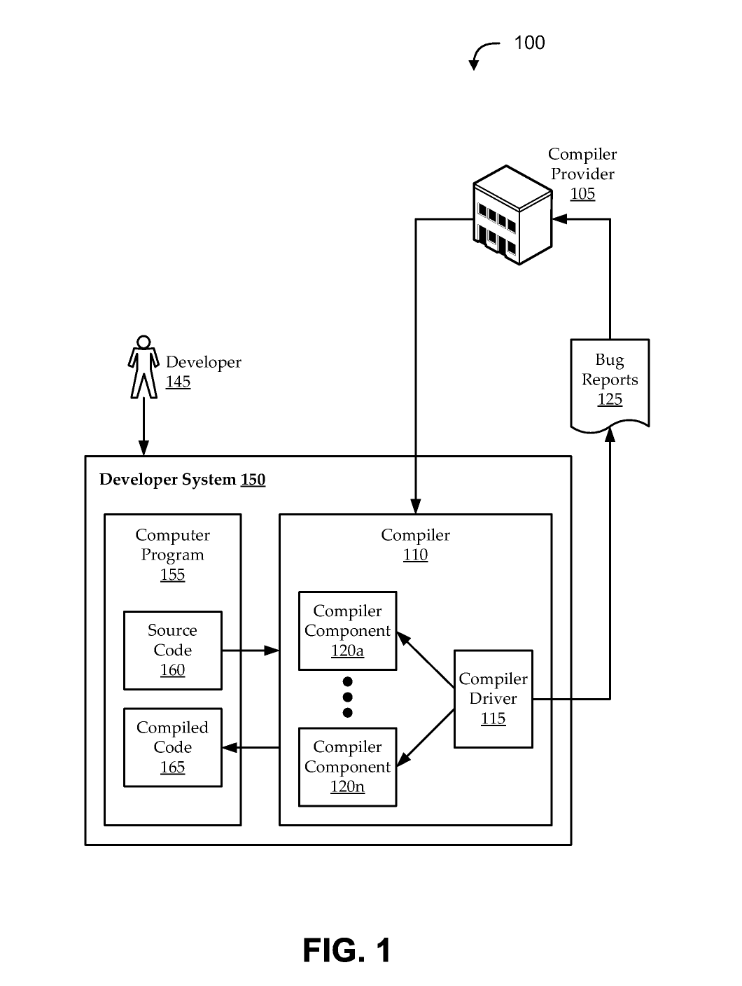

Turning first to FIG. 1, a typical software development environment 100 is shown to provide a context for various embodiments. A compiler provider 105 provides a compiler 110 and/or compiler-related services. For example, the compiler provider 105 is a vendor and/or developer of the compiler 110, an entity that provides service and/or support for the compiler 110, etc.

The compiler 110 includes a number of compiler components 120, each configured to effectuate certain compiler 110 functionality with certain types of code. The compiler 110 also includes a compiler driver 115 (e.g., that may technically be implemented as one of the compiler components 120, but is separated out for the sake of clarity) that is configured to control operation of the other compiler components 120. As used herein, a “compiler component 120” can be a sub-component of another compiler component 120 or can include one or more sub-components.

The compiler 110 runs on a developer system 150 (e.g., a personal computer or other computing platform) to compile source code 160 of a computer program 155 into compiled code 165 (e.g., an executable version) of the computer program 155. A developer 145 (e.g., a software programmer) may develop a computer program 155 by writing and debugging source code 160 in a high-level programming or scripting language, like “Java,” “C,” “PHP,” “Visual Basic,” “Perl,” etc. The developer 145 then sends the source code 160 to the compiler 110 (e.g., which may or may not be stored locally on the developer system 150), which translates the source code 160 to compiled code 165 using its various compiler components 120 as controlled by the compiler driver 115.

At some point during the compilation process, the compiler 110 may encounter an internal fault. For example, compilation of the source code 160 may result in a segmentation fault (e.g., “SEGV”), an assertion error, etc. In a traditional compiler 110 environment, the compiler 110 may terminate the compilation of the source code 160 in response to encountering the internal fault. The developer 145 may then have to manually determine what issue occurred. Further, the developer 145 may have to manually report the issue to the compiler provider 105 (e.g., as a bug report 125), and may have to wait for a fix. Particularly when the compilation process takes a long time or the issue is difficult to detect, this may be highly undesirable for the developer 145. For example, premature termination of the compilation process can significantly impact the software development cycle while waiting for fixes from the compiler provider 105, having to re-compile the source code 160, etc.

Embodiments described herein allow the compiler 110 to recover from internal faults without premature termination. For example, each compiler component 120 is configured to detect an internal compiler error during compilation of the component and identify a recovery plan having a recovery target and at least one recovery setting. The compiler driver 115 can then continue compiling the computer program 155 according to the recovery plan, such that the compilation recompiles from the recovery target and according to a modified set of compiler settings according to the at least one recovery setting.

In some embodiments, the compiler 110 (e.g., the compiler driver 115) is further configured to automatically generate bug reports 125. The compiler 110 may also automatically send the bug reports 125 to the compiler provider 105. Accordingly, the developer 145 can generally avoid having to manually determine internal errors, to manually recompile the computer program 155, or to manually generate and send bug reports 125 to the compiler provider 105.

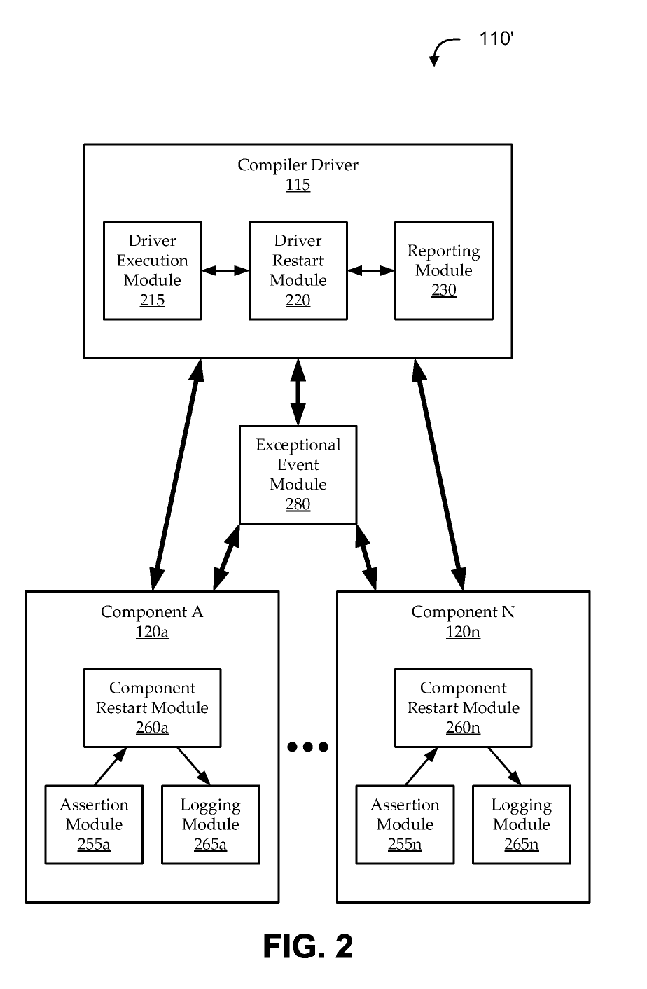

FIG. 2 shows a block diagram of an exemplary compiler 110′, according to various embodiments. As described with reference to FIG. 1, the compiler 110′ includes a compiler driver 115 and various compiler components 120, each having various functional modules. The compiler driver 115 includes a driver execution module 215, a driver restart module 220, and a reporting module 230. Each compiler component 120 includes an assertion module 255, a component restart module 260, and a logging module 265. The compiler 110′ may also include an exceptional event module 280, which is illustrated as separate from the compiler components 120 and the compiler driver 115, though it could be implemented as part of any or all of these embodiments. Each module will be described in turn.

Typically, the compiler 110′ is run with a set of compiler settings. For example, the compiler 110′ can be executed by a command line statement that includes one or more so-called “options” or “flags.” In some implementations, a flag is added to turn on an “unbreakable” mode for the compiler to perform automatic fault handling and/or reporting. For example, a command line statement may include the option: “-xunbreakable[=off|on].” In certain implementations, “on” is the default value, such that the unbreakable mode is automatically invoked if no “-xunbreakable” option is selected. For example, if unbreakable mode is turned off, the compiler 110′ may act substantially as a traditional compiler.

The driver execution module 215 of the compiler driver 115 handles general execution of the compilation. For example, the driver execution module 215 passes appropriate settings and/or other information (e.g., variable values, etc.) to the compiler components 120 and controls execution of those compiler components 120. For example, as compilation proceeds successfully, the driver execution module 215 runs through the compiler components 120 in turn to compile the source code 160 into compiled code 165.

Each compiler component 120 runs according to settings received from the compiler driver 115 (e.g., from the driver execution module 215). If the compiler component 120 completes successfully, it may run substantially as if there were no unbreakable mode. However, if the compiler component 120 encounters an internal fault, the unbreakable mode functionality may be invoked. For example, in unbreakable mode, an execution loop may effectively be created around each compiler component 120 (or groups of compiler components 120) for use in recovering from an internal fault.

There may be various ways to detect an internal fault condition. In some embodiments, each compiler component 120 includes an assertion module 255. The assertion module 255 asserts the expected internal state as the compiler component 120 runs. As the actual internal state of the compiler component 120 deviates from the expected internal state being asserted by the assertion module 255, an internal error condition is detected. This may result in invocation of a restart function and/or a logging function, both described below.

The component restart module 260 handles recovery from the internal fault condition by effectuating a restart function. The restart function involves formulating a recovery plan, which may include a recovery target and one or more recovery settings. The recovery target indicates from where to recompile. For example, it may be desirable to recompile only the failed compiler component 120, to back up to a previously-compiled compiler component 120, or even to perform a full re-compile of the source code 160 (and/or to a sub-component, a position within a component, etc.). The one or more recovery settings may include any type of adjustment to the compiler settings that can impact the chance of a successful recompile of the failed compiler component 120. For example, the recompile may be performed with different optimization levels (e.g., inter-procedural optimization levels), with different parallelization settings (e.g., less automatic parallelization), without executing part of a compiler component 120, by changing execution order of compiler components 120 or portions of compiler components 120, etc.

The recovery plan may be dependent on the type of component that failed, the type of failure that occurred, and/or any other useful factors (e.g., system resources or status, etc.). Accordingly, the component restart module 260 may be tailored to its respective compiler component 120 and may be configured to perform functions like determining which type of fault condition has occurred. The recovery plan is then passed to the driver restart module 220 of the compiler driver 115.

In some embodiments, some or all of the functions of the component restart module 260 are performed at the driver restart module 220. For example, the driver restart module 220 can maintain a set of rules for each compiler component 120 that can be translated into a recovery plan upon encountering an internal fault condition. In various implementations, formulation of the recovery plan by the driver restart module 220 may or may not be according to information received from the component restart module 260.

It is worth noting that the recovery plan may also account for current or prior values of variables, memory locations, etc. For example, the driver restart module 220 and/or the component restart module 260 may formulate the recovery plan according to a location of a particular problem area within the compiler component 120 where the error was encountered, data with which the compiler component 120 was invoked, current data values at the error location, options or other settings with which the compiler component 120 was invoked, etc. The recovery plan may then be tailored to some or all of that information.

Embodiments of the compiler 110′ further include an exceptional event module 280 that may be implemented around the compiler driver 115 and the compiler components 120. The exceptional event module 280 is configured to catch an unexpected compiler driver 115 or compiler component 120 exit due to exceptional events of the underlying system. For example, segmentation faults, bus errors, and/or other issues may be caught by the operating system or the developer's underlying system. These exceptional errors may cause the compiler 110′ to exit prematurely, though the issue is not internal to the compiler component 120 currently being executed by the compiler driver 115.

Implementations of the exceptional event module 280 include a signal handler configured to detect indications of exceptional events generated by the underlying system. When a signal is detected that indicates an exceptional event, the exceptional event module 280 may act similarly to the assertion module 255 of a compiler component 120. The exceptional event module 280 will indicate that an exceptional event has been detected, and restart and/or logging functionality is then invoked. For example, a recovery plan is formulated according to the exceptional event and/or other information, and the recovery plan may include a recovery target and one or more recovery settings. The driver restart module 220 can use the recovery plan to restart one or more components from a last correct state of the compile process.

In some embodiments, a logging function is included in the compiler 110′, which may be implemented by the reporting module 230 of the compiler driver 115 and/or the logging module 265 of the compiler component 120. Implementations include a common logging specification that defines what types of data are logged by each component upon encountering an internal compiler fault. This may help simplify identification of the type and location of an error, improve reproducibility of remedial measures or subsequent debugging efforts, etc. The common logging specification may include, for example, a source file (or some representation thereof), options with which the failed component was invoked, an identification of the failed component, a type of failure encountered, a machine state at the time of failure, a version of the compiler 110′, etc. Notably, the information may be generated by some or all of the logging modules 265 of the compiler components 120, the exceptional event module 280, and the reporting module 230 of the compiler driver 115.

In some embodiments, the compiler 110′ is configured to automatically generate a bug report based on the logged data. Further, in some embodiments, the compiler 110′ is configured to automatically communicate the bug report to a compiler vendor. For example, the logging module 265 collects relevant information upon encountering an internal fault condition. The information is communicated to the reporting module 230, which generates a bug report according to a predefined format. The reporting module 230 then sends the bug report (e.g., over the Internet) to a compiler vendor or other support center. Certain implementations allow the developer to decide whether to automatically log error data, whether to generate a bug report, and/or whether to communicate the bug report.

Reporting to the compiler vendor may be implemented in various ways. In some implementations, an email message is sent to the developer and/or a report is displayed in the development environment (e.g., an integrated development environment, or IDE). Alternately, a report web page may be displayed in the developer's web browser (e.g., which may automatically be called up). With the reported information, the developer may then be able to send a bug report to the compiler vendor. In other implementations, the bug reports are further automated. For example, the messages sent to the developer indicate that a bug report has already been generated and send to the compiler vendor.

The compiler vendor can also handle the bug reports in various ways. For example, the compiler vendor can automate inclusion of the bug report in a tracking system. The tracking system can be used to group similar reported internal errors for efficient remediation, to maintain databases and reports of resolution status for reported internal errors, track trends and/or other analytics, etc. Further, the tracking system can be used to provide feedback to the developers, including, for example, a status of resolution for their reported internal error, availability of a patch or fix, etc.

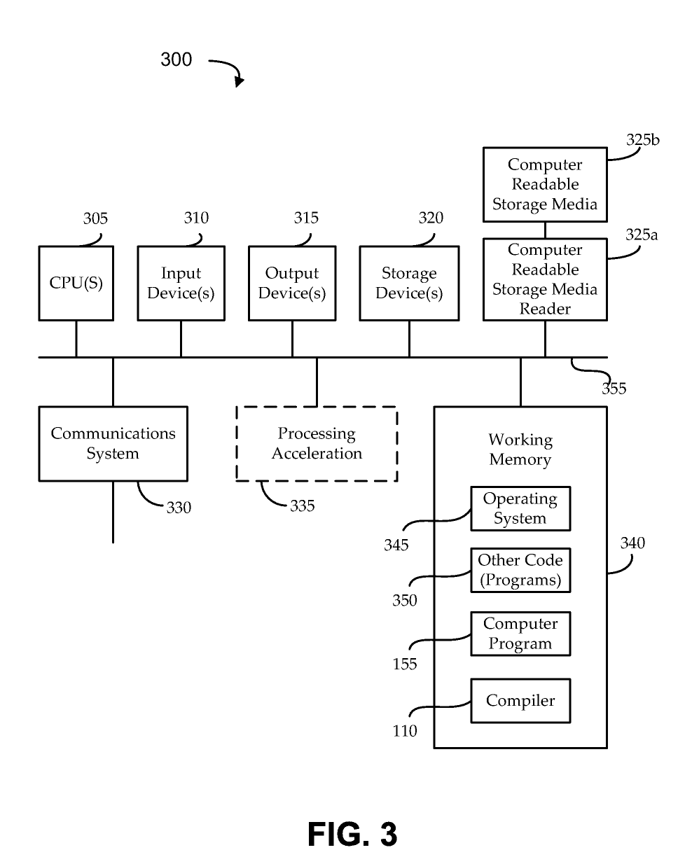

As described above, the compiler 110 functionality is implemented in a computational environment, such as developer system 150 of FIG. 1. FIG. 3 shows an exemplary computational environment 300, in the context of which various embodiments may be implemented. The computational environment 300 may be implemented as or embodied in single or distributed computer systems, or in any other useful way. The computational environment 300 is shown including hardware elements that may be electrically coupled via a bus 355.

The hardware elements may include one or more central processing units (CPUs) 305, one or more input devices 310 (e.g., a mouse, a keyboard, etc.), and one or more output devices 315 (e.g., a display device, a printer, etc.). The computational environment 300 may also include one or more storage devices 320. By way of example, storage device(s) 320 may be disk drives, optical storage devices, solid-state storage device such as a random access memory (RAM) and/or a read-only memory (ROM), which can be programmable, flash-updateable and/or the like.

The computational environment 300 may additionally include a computer-readable storage media reader 325a, a communications system 330 (e.g., a modem, a network card (wireless or wired), an infra-red communication device, etc.), and working memory 340, which may include RAM and ROM devices as described above. In some embodiments, the computational environment 300 may also include a processing acceleration unit 335, which can include a DSP, a special-purpose processor and/or the like.

The computer-readable storage media reader 325a can further be connected to a computer-readable storage medium 325b, together (and, optionally, in combination with storage device(s) 320) comprehensively representing remote, local, fixed, and/or removable storage devices plus storage media for temporarily and/or more permanently containing computer-readable information. The communications system 330 may permit data to be exchanged with a network and/or any other computer described above with respect to the computational environment 300. For example, as described with reference to FIGS. 1 and 2, bug reports and/or other information may be communicated with a compiler vendor over the Internet via the communications system 330.

The computational environment 300 may also include software elements, shown as being currently located within a working memory 340, including an operating system 345 and/or other code 350, such as an application program (which may be a client application, web browser, mid-tier application, RDBMS, etc.). As described above, embodiments of the compiler 110 may interact with a computer program 155 in working memory 340. As described above, a compiler 110 is a set of programs for translating source code 160 into another computer language, or target code (e.g., compiled code 165).

For example, software code may typically be written by a programmer designer in a high-level language such as C, C++, Fortran, or other. This so-called source code 160 may be stored on a computer readable medium (e.g., storage device(s) 320 or computer readable storage medium 325b). A command instruction, which may be entered at a prompt by a user or placed within a scripting language with any necessary options, may be executed in order to compile the source code 160.

As described herein, embodiments of the compiler 110 are implemented as a series of compiler components 120 executed by a compiler driver 115. In unbreakable mode, the compiler driver 115 effectively implements an execution loop around each compiler component 120. This can then be used to facilitate restart, logging, and/or other functionality.

It should be appreciated that alternate embodiments of a computational environment 300 may have numerous variations from that described above. For example, customized hardware might also be used and/or particular elements might be implemented in hardware, software (including portable software, such as applets), or both. Further, connection to other computing devices such as network input/output devices may be employed. Software of the computational environment 300 may include code 350 for implementing embodiments of the present invention as described herein.

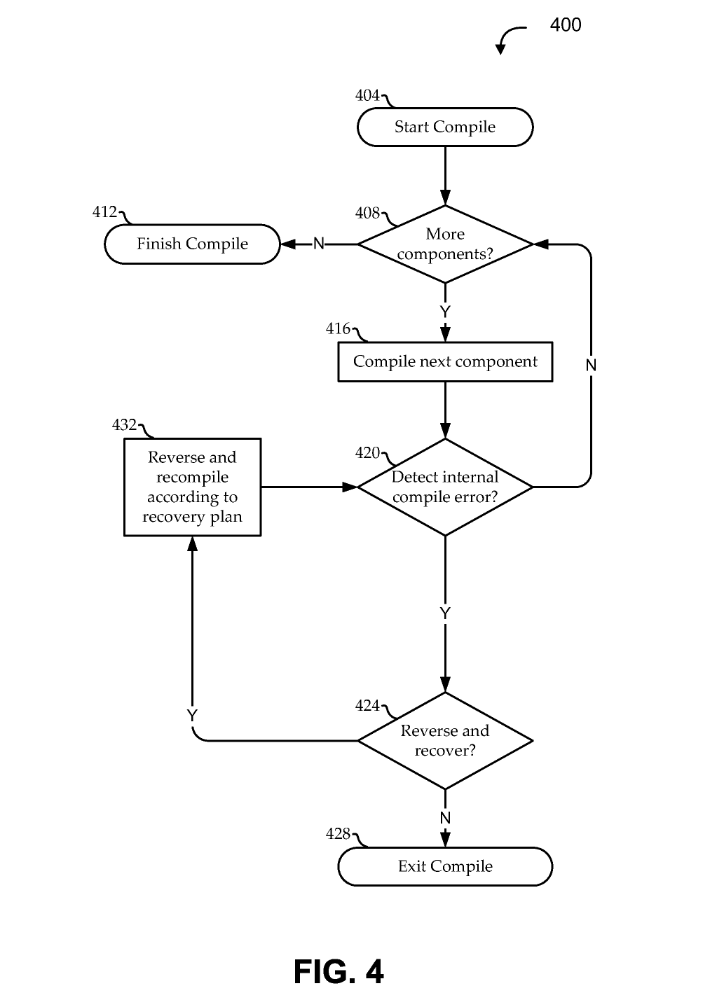

It will be appreciated that various systems, including the systems described above in FIGS. 1-3, can be used to implement embodiments of the unbreakable compile mode techniques described herein. Some embodiments are further described according to the methods of FIGS. 4-6. Where the methods are described in the context of specific system components, those descriptions are intended only for the sake of clarity and should not be construed as limiting the scope of any embodiments.

Turning to FIG. 4, a flow diagram is shown of an illustrative method 400 for compiling in unbreakable mode, according to various embodiments. The method 400 begins at block 404 when the compilation of a computer program begins. For example, a compiler 110 begins to compile source code 160 of a computer program on a developer system 150 by using its compiler driver 115 to execute through a number of compiler components 120. As the compilation process proceeds, a determination is made at block 408 as to whether any components remain to be compiled. If no components remain to be compiled, the compilation process ends at block 412.

If it is determined at block 408 that components remain to be compiled, compilation of the next component is attempted at block 416. During compilation of the component, a determination is made at block 420 as to whether an internal error is encountered. For example, as described above, the assertion module 255 of the current compiler component 120 or the exceptional event module 280 detects a fault condition that would cause the compiler to exit prematurely if not in unbreakable mode. If no internal error is encountered during compilation of the component, it is assumed for the sake of simplicity that compilation of the component was successful (handling of other types of errors during compilation of a compiler component is outside the scope of the disclosure). Accordingly, the method 400 continues by determining once again at block 408 if any components remain and, if so, compiling the next component at block 416.

If it is determined at block 420 that an internal error has been encountered during compilation of the component, a determination is made at block 424 as to whether a recovery plan is available to allow the compiler to reverse and recover from the internal error. For example, a number of possible recovery plans may be associated with the failed component. Still, in some cases, recovery may be unavailable. For example, all the possible recovery plans may already have been attempted, the compiler may have run out of memory, the failed component may not be associated with any recovery plans, etc. In any of these or other cases where recovery is unavailable, the compiler exits at block 428. It will be appreciated that every attempt may be made to force the compiler to exit gracefully, many techniques for which are known in the art.

If it is determined at block 424 that a recovery plan is available to allow the compiler to reverse and recover from the internal error, the compiler reverses and recompiles according to the recovery plan at block 432. For example, the recovery plan defines a recovery target and recovery settings. The compiler driver 115 restarts the recompilation process from a component or sub-component corresponding to the recovery target (e.g., the beginning of the failed component) and using new compiler settings according to the recovery settings (e.g., using a different inter-procedural optimization level).

During recompilation of the one or more components at block 432, the method 400 again determines whether an internal error is encountered at block 420. The method 400 continues to cycle through recovery options until either a determination is made at block 424 that recovery is unavailable resulting in an exit of the compilation at block 428; or a determination is made at block 420 that no internal error is encountered, indicating that recovery is successful. As components successfully compile and/or successful recoveries are made, the method 400 cycles through remaining components at block 416 until no components remain, and compilation ends at block 412.

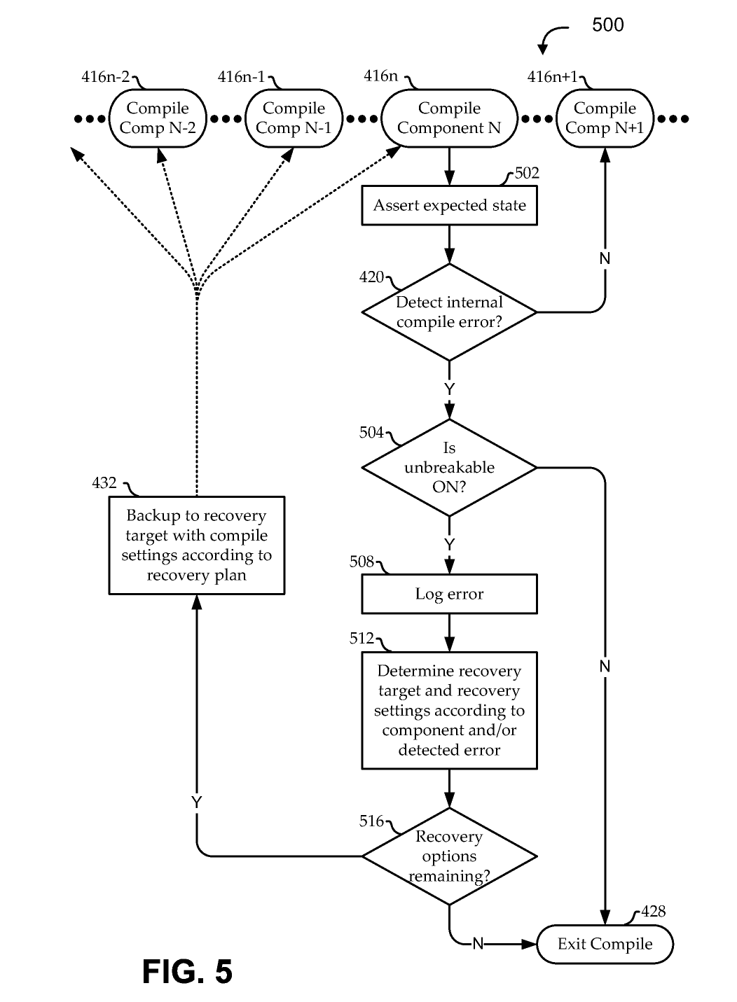

A flow diagram of another illustrative method 500 for compiling in unbreakable mode is shown in FIG. 5. For the sake of clarity similar blocks to those in FIG. 4 are shown with the same reference numbers. The method 500 is illustrated as executing serially through a number of compiler components at blocks 416n−2, 416n−1, 416n, 416n+1, etc. For illustrative purposes, the method is currently compiling component N at block 416n.

During compilation of component N at block 416n, an expected state is asserted at block 502. For example, the assertion module 255 of component N continually asserts the expected internal state so that deviations from that expected state can be detected. In some embodiments, as described above, techniques are also used to detect occurrences of exceptional events outside component N. For example, the exceptional event module 280 includes signal handling capability for handling signals from the underlying system indicating an exceptional event.

At block 420, a determination is made as to whether an internal error is encountered (e.g., according to the assertion module 255 and/or the exceptional event module 280). If no internal error is encountered, the method 500 may proceed to compile the next component, component N+1, at block 416n+1. If an internal error is detected at block 420, a further determination is made at block 504 as to whether unbreakable mode is on. For example, the method 500 may be invoked using a command-line statement having various options, one of which being whether or not unbreakable mode is on. In some embodiments, the determination at block 504 is made prior to any detection at block 420 (e.g., the detection at block 420 only occurs if the compiler 110 is in unbreakable mode). If unbreakable mode is off, method 500 may simply exit at block 428 (e.g., gracefully, whenever possible). If unbreakable mode is on, the method 500 may proceed to implement unbreakable mode functionality.

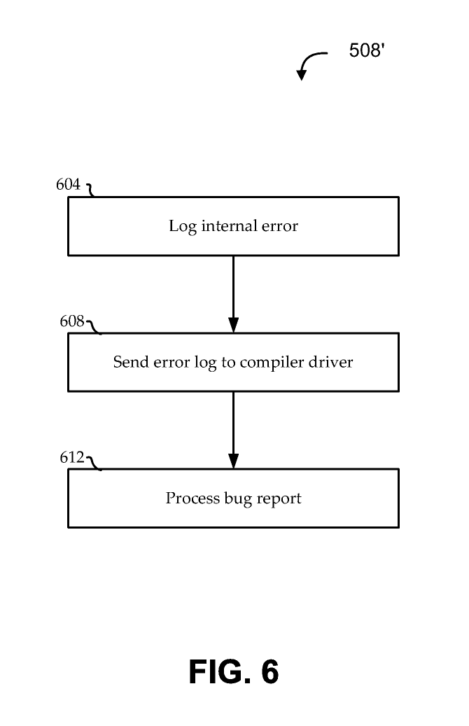

In some embodiments, the method 500 may proceed by logging the error at block 508. For example, FIG. 6 shows an illustrative method 508′ for logging the error, according to various embodiments. The method 508′ begins at block 604 by logging the internal error. For example, the logging module 265 of component N collects relevant information relating to the internal error. In some cases, when the internal error is an exceptional error, the exceptional event module 280 may gather the relevant information.

The information is sent to the compiler driver 115 at block 608. As discussed above, in some implementations, the compiler driver 115 gathers some or all of the relevant information for the error log. The compiler driver 115 may then process a bug report at block 612. Processing the bug report may include generating the bug report, communicating the bug report to the developer, communicating the bug report to the compiler vendor, etc.

Returning to FIG. 5, the method 500 may continue by determining a recovery plan at block 512 according to the detected internal error. In some embodiments, all recovery plans are the same, regardless of the failure. For example, the recovery plan always attempts to restart the failed component with new settings according to an ordered list of new settings to attempt. In other embodiments, the recovery plans are associated with individual components and/or individual types of internal errors. For example, the compiler vendor may generate recovery plans for each compiler component 120, which may be maintained by the compiler driver 115. Typically, multiple recovery plan options are available and configured to be attempted in a predetermined order.

At block 516, a determination is made as to whether any recovery plan options remain. For example, if all the recovery plan options have already been attempted, it will be determined that no recovery plan options remain. In the event that no recovery plan options remain, the method 500 may exit at block 428. Ideally, this would never occur, as a successful recovery would hopefully occur before the method 500 runs out of recovery plan options. However, certain unrecoverable internal errors may be encountered even in unbreakable mode, and the method 500 may have to end prematurely in limited cases.

As described with reference to FIG. 4, if it is determined at block 516 that a recovery plan option is available, the compiler reverses and recompiles according to the recovery plan at block 432. In some implementations, the compiler driver 115 restarts the recompilation process from a component or sub-component corresponding to the recovery target using new compiler settings according to the recovery settings. For example, as illustrated, the method 500 proceeds by compiling from any of the previously compiled components at blocks 416n−2, 416n−1, 416n, etc.

The recovery plan options are designed to hopefully produce a successful recompilation (i.e., an avoidance of the internal compiler error upon recompile of the component). Accordingly, after one or more attempts, the method 500 should be able to move past compiling component N at block 416n to compiling component N+1 at block 416n+1. As such, the method 500 should hopefully compile all the components for a successful compilation of the full source code 160 without encountering internal errors.

It will be appreciated that the recovery can be performed at different levels of transparency. At one level of transparency, the recovery may occur without any interaction from or notice to the developer or the vendor. At other levels of transparency, various messages may be communicated with the developer and/or the vendor, even if the compilation is successful. For example, the developer may desire to know that certain selected settings were automatically changed in the course of recovery by the compiler. In another example, the vendor may desire to know that an internal error occurred, even though the error did not result in premature termination of the compilation process.

The various operations of methods described above may be performed by any suitable means capable of performing the corresponding functions. The means may include various hardware and/or software component(s) and/or module(s), including, but not limited to a circuit, an application specific integrated circuit (ASIC), or processor.

The various illustrative logical blocks, modules, and circuits described may be implemented or performed with a general purpose processor, a digital signal processor (DSP), an ASIC, a field programmable gate array signal (FPGA), or other programmable logic device (PLD), discrete gate, or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure, may be embodied directly in hardware, in a software module executed by a processor, or in a combination of the two. A software module may reside in any form of tangible storage medium. Some examples of storage media that may be used include random access memory (RAM), read only memory (ROM), flash memory, EPROM memory, EEPROM memory, registers, a hard disk, a removable disk, a CD-ROM and so forth. A storage medium may be coupled to a processor such that the processor can read information from, and write information to, the storage medium. In the alternative, the storage medium may be integral to the processor. A software module may be a single instruction, or many instructions, and may be distributed over several different code segments, among different programs, and across multiple storage media.

The methods disclosed herein comprise one or more actions for achieving the described method. The method and/or actions may be interchanged with one another without departing from the scope of the claims. In other words, unless a specific order of actions is specified, the order and/or use of specific actions may be modified without departing from the scope of the claims.

The functions described may be implemented in hardware, software, firmware, or any combination thereof. If implemented in software, the functions may be stored as one or more instructions on a tangible computer-readable medium. A storage medium may be any available tangible medium that can be accessed by a computer. By way of example, and not limitation, such computer-readable media can comprise RAM, ROM, EEPROM, CD-ROM, or other optical disk storage, magnetic disk storage, or other magnetic storage devices, or any other tangible medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, a computer program product may perform operations presented herein. For example, such a computer program product may be a computer readable tangible medium having instructions tangibly stored (and/or encoded) thereon, the instructions being executable by one or more processors to perform the operations described herein. The computer program product may include packaging material.

Software or instructions may also be transmitted over a transmission medium. For example, software may be transmitted from a website, server, or other remote source using a transmission medium such as a coaxial cable, fiber optic cable, twisted pair, digital subscriber line (DSL), or wireless technology such as infrared, radio, or microwave.

Further, modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples.

Various changes, substitutions, and alterations to the techniques described herein can be made without departing from the technology of the teachings as defined by the appended claims. Moreover, the scope of the disclosure and claims is not limited to the particular aspects of the process, machine, manufacture, composition of matter, means, methods, and actions described above. Processes, machines, manufacture, compositions of matter, means, methods, or actions, presently existing or later to be developed, that perform substantially the same function or achieve substantially the same result as the corresponding aspects described herein may be utilized. Accordingly, the appended claims include within their scope such processes, machines, manufacture, compositions of matter, means, methods, or actions.

What is claimed is:

1. A method comprising:
detecting an internal compiler error during compilation of a component of a computer program by a computer-implemented compiler according to a set of compiler settings;
identifying a recovery plan associated with the component, the recovery plan comprising a recovery target and at least one recovery setting; and
continuing the compilation of the computer program by the computer-implemented compiler according to the recovery plan, such that the compilation continues at a previously compiled location according to the recovery target and according to a modified set of compiler settings being the set of compiler settings modified according to the at least one recovery setting.

2. The method of claim 1, wherein the identifying step comprises:
identifying a set of recovery plans associated with the component;
determining that at least one of the set of recovery plans has not been previously attempted after a previously failed compilation of the component; and
identifying the recovery plan as one of the set of recovery plans that has not been previously attempted after a previously failed compilation of the component.

3. The method of claim 1, wherein the identifying step comprises:
identifying a set of recovery plans associated with the component; and
determining whether any of the set of recovery plans has not been previously attempted after a previously failed compilation of the component,
wherein the continuing step is performed only when at least one of the set of recovery plans has not been previously attempted after a previously failed compilation of the component.

4. The method of claim 1, further comprising:
determining whether the compilation is running in an unbreakable mode according to the set of compiler settings,
wherein the identifying step and the continuing step are performed only when the compiler is running in the unbreakable mode.

5. The method of claim 1, further comprising automatically logging the internal error in response to detecting the internal error.

6. The method of claim 5, wherein automatically logging the internal error comprises:
sending log data to a driver of the compiler; and
generating a bug report according to the log data at the driver.

7. The method of claim 1, further comprising:
asserting an expected internal state for the component,
wherein detecting the internal compiler error comprises detecting that an actual internal state for the component is different from the expected internal state for the component.

8. The method of claim 1, further comprising:
detecting occurrence of an exceptional event in an underlying system on which the compilation is running;
identifying an event handling plan associated with the exceptional event, the event handling plan comprising an event handling target and at least one event handling setting; and
directing the driver subsystem to continue compiling the components of the computer program according to the event handling plan, such that the compilation continues at a previously compiled location according to the event handling target and according to a modified set of compiler settings being the set of compiler settings modified according to the at least one event handling setting.

9. The method of claim 1, further comprising:
generating a compilation loop around at least the component prior to compiling the component,
wherein the recovery target is the beginning of the compilation loop and
wherein the component of the computer program is part of a larger component.

10. A computer-implemented compiler system comprising:
a driver subsystem, configured to compile a computer program according to a set of compiler settings; and
a plurality of component subsystems, each corresponding to a portion of the computer program, and each comprising a restart module configured to:
detect an internal compiler error during compilation of one of the components by the driver execution subsystem;
identify a recovery plan associated with the component, the recovery plan comprising a recovery target and at least one recovery setting; and
direct the driver subsystem to continue compiling the components of the computer program according to the recovery plan, such that the compilation continues at a previously compiled location according to the recovery target and according to a modified set of compiler settings being the set of compiler settings modified according to the at least one recovery setting.

11. The system of claim 10, wherein the restart module is configured to identify the recovery plan by:
identifying a set of recovery plans associated with the component;
determining that at least one of the set of recovery plans has not been previously attempted after a previously failed compilation of the component; and
identifying the recovery plan as one of the set of recovery plans that has not been previously attempted after a previously failed compilation of the component.

12. The system of claim 10, wherein the restart module is configured to identify the recovery plan by:
identifying a set of recovery plans associated with the component; and
determining whether any of the set of recovery plans has not been previously attempted after a previously failed compilation of the component,
wherein the restart module directs the driver subsystem to continue compiling according to the recovery plan only when at least one of the set of recovery plans has not been previously attempted after a previously failed compilation of the component.

13. The system of claim 10, wherein the restart module is further configured to:
determine whether the driver subsystem is configured to run in an unbreakable mode according to the set of compiler settings,
wherein the restart module identifies the recovery plan and directs driver execution subsystem to continue compiling according to the recovery plan only when the driver execution subsystem is configured to run in the unbreakable mode.

14. The system of claim 10, each component subsystem further comprising:
a logging module configured to automatically log the internal error in response to the restart module detecting the internal error.

15. The system of claim 14, wherein the driver subsystem comprises a reporting module configured to:
receive log data from the logging module in response to the logging module automatically logging the internal error; and
generate a bug report according to the log data.

16. The system of claim 15, wherein the reporting module is further configured to:
communicate the bug report to a remote entity associated with providing the driver subsystem.

17. The system of claim 10, each component subsystem further comprising:
an assertion module configured to assert an expected internal state for the component,
wherein the restart module is configured to detect the internal compiler error when it detects that an actual internal state for the component is different from the expected internal state for the component.

18. The system of claim 10, further comprising an exceptional event handling subsystem configured to:
detect occurrence of an exceptional event in an underlying system on which the driver subsystem is running;
identify an event handling plan associated with the exceptional event, the event handling plan comprising an event handling target and at least one an event handling setting; and
direct the driver subsystem to continue compiling the components of the computer program according to the event handling plan, such that the compilation continues at a previously compiled location according to the event handling target and according to a modified set of compiler settings being the set of compiler settings modified according to the at least one event handling setting.

19. The system of claim 10, each component subsystem further comprising:
a machine-readable medium having stored thereon a series of instructions which, when executed by a processor, cause the processor to direct operation of the driver subsystem and the plurality of component subsystems.

20. A compiling method comprising:
detecting an internal compiler error during compilation of a component of a computer program by a computer-implemented compiler;
identifying a recovery plan associated with the component among a set of recovery plans, the recovery plan comprising a recovery target and the recovery plan being determined to not have been previously attempted after a failed compilation of the component; and
continuing the compilation of the computer program by the computer-implemented compiler according to the recovery plan at a previously compiled location according to the recovery target and according to a modified set of compiler settings.
